(19) United States
(12) Patent Application Publication
(10) Pub. No.: US 2026/0230685 A1
(43) Pub. Date: Aug. 6, 2026

(54) MOTION CUSTOMIZATION VIA SHARED ATTENTION

(71) Applicant: QUALCOMM Incorporated, San Diego, CA (US)

(72) Inventors: Sunghyun PARK, Seoul (KR); Seokeon CHOI, Yongin-si (KR); Sungrack YUN, Seongnam (KR)

(21) Appl. No.: 19/045,372

(22) Filed: Feb. 4, 2025

(51) Int. Cl. H04N 21/81; G06T 7/246; G06V 10/44

(52) U.S. Cl. CPC H04N 21/816; G06T 7/246; G06V 10/44

(57) ABSTRACT

Techniques are described for generating personalized image content. A device may at least one memory. A device may at least one processor coupled to the at least one memory and configured to: process, using a first machine learning model, a reference image and a reference video including inverted noise to generate first features, process, using a second machine learning model, the reference image and Gaussian noise to generate second features, process, using one or more shared attention layers, the first features from the first machine learning model and the second features from the second machine learning model to generate shared attention features; and process, using the second machine learning model, the shared attention features to generate an output video.

### TECHNICAL FIELD

The present disclosure generally relates to electronically generated content. For example, aspects of the present disclosure include systems and techniques for generating personalized content (e.g., video content) based on motion customization via shared attention using one or more machine learning models.

### BACKGROUND

Content personalization involves using digital techniques to create digital content such as images or videos. For example, a user may provide content to a system and ask that the system apply a particular action or style to the content to generate new content. However, existing approaches are unable to reliably separate motion and appearance related content from source material.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating video content. In some aspects, an apparatus for generating image content is provided. The apparatus includes at least one memory and at least one processor coupled to the at least one memory and configured to: process, using a first machine learning model, a reference image and a reference video including inverted noise to generate first features; process, using a second machine learning model, the reference image and Gaussian noise to generate second features; process, using one or more shared attention layers, the first features from the first machine learning model and the second features from the second machine learning model to generate shared attention features; and process, using the second machine learning model, the shared attention features to generate an output video.

In some aspects, a method for generating image content is provided. The method includes: processing, using a first machine learning model, a reference image and a reference video including inverted noise to generate first features; processing, using a second machine learning model, the reference image and Gaussian noise to generate second features; processing, using one or more shared attention layers, the first features from the first machine learning model and the second features from the second machine learning model to generate shared attention features; and processing, using the second machine learning model, the shared attention features to generate an output video.

In some aspects, a non-transitory computer-readable medium is provided that has stored thereon instructions that, when executed by one or more processors, cause the one or more processors to: process, using a first machine learning model, a reference image and a reference video including inverted noise to generate first features; process, using a second machine learning model, the reference image and Gaussian noise to generate second features; process, using one or more shared attention layers, the first features from the first machine learning model and the second features from the second machine learning model to generate shared attention features; and process, using the second machine learning model, the shared attention features to generate an output video.

In some aspects, an apparatus for generating image content is provided. The apparatus includes: means for processing a reference image and a reference video including inverted noise to generate first features; means for processing the reference image and Gaussian noise to generate second features; means for processing the first features from the first machine learning model and the second features from the second machine learning model to generate shared attention features; and means for processing the shared attention features to generate an output video.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example apparatus for generating image content, according to various aspects of the present disclosure;

FIG. 2 includes two sets of images that show the forward diffusion process (which is fixed) and the reverse diffusion process (which is learned) of a diffusion model, according to various aspects of the present disclosure;

FIG. 3 is a diagram illustrating how diffusion data is distributed from initial data to noise using a diffusion model in the forward diffusion direction, in accordance with some aspects of the present disclosure;

FIG. 4 is a diagram illustrating a U-Net architecture for a diffusion model, in accordance with some aspects of the present disclosure;

FIG. 5 is a diagram illustrating a system for motion customization via shared attention, in accordance with some aspects of the present disclosure.

FIG. 6 is a diagram illustrating a system for motion customization via shared attention, in accordance with some aspects of the present disclosure.

FIG. 7 is a diagram illustrating a shared attention layer, in accordance with some aspects of the present disclosure.

FIG. 8 is a flow diagram of an example of a process for generating content in accordance with some aspects of the disclosure;

FIG. 9 is an illustrative example of a neural network (e.g., a deep-learning neural network), in accordance with some aspects of the present disclosure;

FIG. 10 is a block diagram of an example transformer in accordance with some aspects of the disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Certain aspects described herein relate to machine learning for content personalization. Content personalization may include using digital techniques to create digital content such as videos from one or more items of reference content such as videos and/or images. As explained below, disclosed techniques include using machine learning models (e.g., diffusion models, other types of transformer-based models, and/or other types of machine learning models) that are interconnected via one or more temporal shared attention layers to improve content personalization.

Various aspects of the application will be described with respect to the figures below.

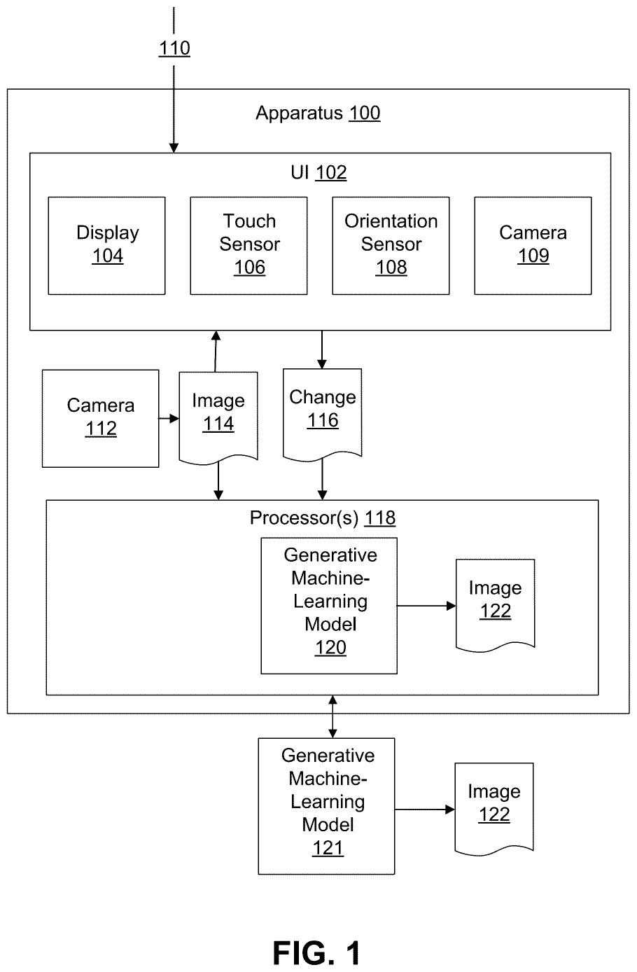

FIG. 1 is a block diagram illustrating an example apparatus 100 for generating image content, according to various aspects of the present disclosure. In general, camera 112 of apparatus 100 may capture image 114. In some aspects, apparatus 100 may obtain image 114 from another source, for example, another computing device may transmit image 114 to apparatus 100 via a communication interface (not illustrated in FIG. 1). Image 114 may represent a field of view of a scene. User interface (UI 102) of apparatus 100 may display image 114 at a display 104 of UI 102. UI 102 may receive a user input 110 indicative of a desired change 116 to image 114 (e.g., at a touch sensor 106 and/or using an orientation sensor 108). The desired change 116 to image 114 may be, or may include, a change to the field of view of image 114. Apparatus 100 may use a generative machine-learning model (e.g., generative machine-learning model 120 and/or generative machine-learning model 121) to generate image 122 (which may include a least a part of image 114 altered according to change 116) in response to user input 110. Apparatus 100 may provide at least a part of image 114 to generative machine-learning model 120 (or generative machine-learning model 121) as a condition. Further, Apparatus 100 may provide instructions to generative machine-learning model 120 (or generative machine-learning model 121) regarding the generation of image 122. The instructions may be based on change 116. Generative machine-learning model 120 (or generative machine-learning model 121) may generate image 122 to include at least a part of image 114 of the field of view and generated pixels outside of the field of view based on the change 116 to the field of view.

Apparatus 100 may be, or may include, any suitable apparatus including a UI 102 and one or more processor(s) 118. For example, apparatus 100 may be a mobile device (e.g., a mobile phone), a camera, a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the operations described with regard to apparatus 100. In some aspects, apparatus 100 may include camera 112 to captured image 114. In other aspects, apparatus 100 may not include camera 112 and image 114 may be obtained from a camera external to apparatus 100.

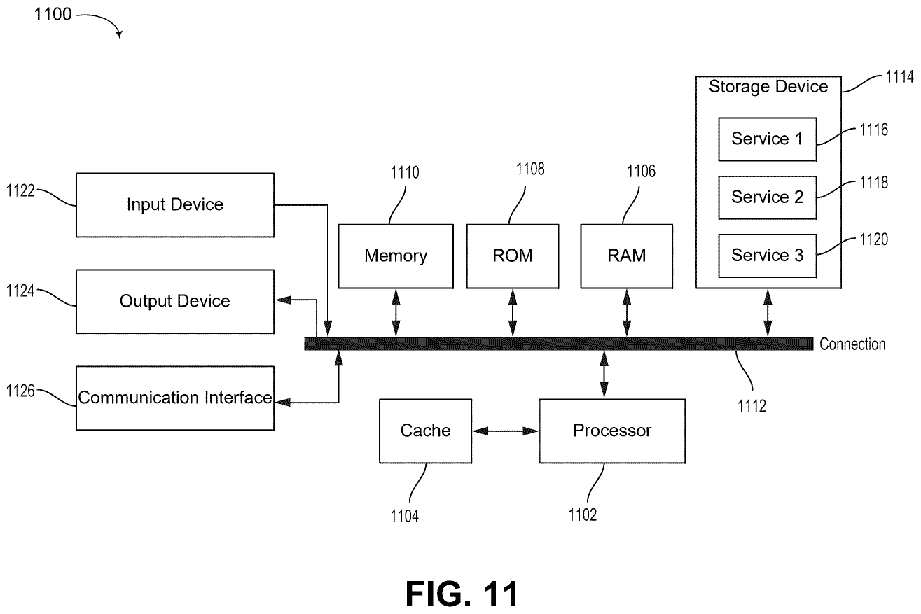

Camera 112 of apparatus 100 may include an array of photosensors that convert light into image data. Camera 112 may include a lens to focus light from a field of view of a scene onto the array of photosensors. Camera 112 may generate image 114 which may be representative of the field of view, for example, image 114 may include data representative of colors and intensities of light received by the photosensors from the field of view. Computing-device architecture 1100 of FIG. 11 may be an example of camera 112. In some aspects, apparatus 100 may receive image 114 from another source. For example, apparatus 100 may be receive image 114 via a communications interface.

UI 102 may be, or may include, any suitable means for a user to provide user input 110 to apparatus 100 and for apparatus 100 to provide output to the user (e.g., to display image 114 and/or image 122 to the user). UI 102 may include hardware (e.g., display 104, touch sensor 106, and orientation sensor 108 and/or a camera 109), as well as firmware and/or software to control and interface with the hardware. UI 102 may use display 104 to display images (including image 114 and/or image 122) to the user. UI 102 may use touch sensor 106 to receive user input 110. Touch sensor 106 may be a capacitive touch screen. Touch sensor 106 may be integrated with or layered with display 104, for example, such that a user may provide input relative to image 114. For example, touch sensor 106 may be integrated with display 104 such that the user may touch touch sensor 106 in locations that correspond to points of image 114 as displayed at display 104. In this way, UI 102 may receive input relative to image 114. Additionally or alternatively, UI 102 may use orientation sensor 108 of UI 102 to receive user input 110 based on an orientation of orientation sensor 108 and/or display 104. Orientation sensor 108 may be, or may include, any suitable means for determining an orientation of apparatus 100 or of display 104. For example, orientation sensor 108 may include one or more inertial measurement units or gravity-based switches. Additionally or alternatively, UI 102 may use camera 109 (which may include one or more cameras on one or more surfaces of apparatus 100) to capture images (e.g., of a user). Camera 109 may be, or may include, for example, an active-depth camera, an infrared (IR) camera, a red-green-blue (RGB) camera, stereo cameras, an eye-facing camera, or any combination thereof. UI 102 may detect gestures in images of a user of apparatus 100. UI 102 may interpret the gestures as user input. For example, UI 102 may interpret hand gestures to receive the user input; additionally or alternatively, UI 102 may interpret eye movements to receive user input. Thus, UI 102 may implement a hand tracking technique and/or an eye tracking technique. Additionally or alternatively, UI 102 may include a keyboard, a keypad, a trackpad, any other output devices, any other input devices, or any combination thereof.

UI 102 may receive user input 110 and interpret user input 110 relative to image 114. More specifically, UI 102 may interpret user input 110 as in indication of a desired change 116 to a field of view of image 114. For example, a user may perform a pinch touch gesture on touch sensor 106 (e.g., touching touch sensor 106 at two separate points and bringing the touched points together). UI 102 may interpret the pinch touch gesture as a desire to expand a field of view of image 114. As another example, the user may perform a drag touch gesture on touch sensor 106 (e.g., touching one or more points of touch sensor 106 and moving the touched one or more points in a direction, such as in a substantially straight line). UI 102 may interpret the drag touch gesture as a desire to pan the field of view of image 114. As another example, the user may perform a rotating touch gesture on touch sensor 106 (e.g., touching one or more points of touch sensor 106 and moving the touched one or more points in an arc). UI 102 may interpret the rotating touch gesture as a desire rotate the field of view within a frame of image 114. As another example, the user may rotate apparatus 100. UI 102 may interpret the rotating of apparatus 100 as a desire to rotate a frame of image 114 (e.g., from a landscape frame to a portrait frame or vice versa). As another example, a user may wave both hands to one side to indicate a desire to pan. Camera 109 may capture images of the user waving both hands and UI 102 may track the hands in the images and interpret the waving hands as a desire to pan. As another example, apparatus 100 may be, or may be included in a head-mounted device. Camera 109 may face eyes of a user. The user may hold their gaze at a side of an image. UI 102 may interpret the gaze as a desire to pan the image to that side. UI 102 may generate change 116 which may be data indicative of the desired change. For example, change 116 may encode the desired change as an instruction relative to image 114.

Processor(s) 118 may be, or may include, one or more suitable processors configured to perform computing operations. Computing-device architecture 1100 of FIG. 11 may be examples of processor(s) 118. Processor(s) 118 may, among other things, implement generative machine-learning model 120. Additionally or alternatively, processor(s) 118 may be in communication with another computing device (e.g., a server computer or a laptop computer, not illustrated in FIG. 1) that may implement generative machine-learning model 121. Generative machine-learning model 121 may be the same as, substantially the same as, perform the same, or substantially the same operations as, generative machine-learning model 120. All descriptions of operations performed by generative machine-learning model 120 and/or training of generative machine-learning model 120 apply to generative machine-learning model 121 as well. All operations described as being performed by generative machine-learning model 120 may, additionally or alternatively, be performed by generative machine-learning model 121. Generative machine-learning model 120 (and/or generative machine-learning model 121) may be a trained generative machine-learning model capable of generating new image data based on provided conditions and/or instructions.

Apparatus 100 may provide at least a part of image 114 to generative machine-learning model 120 (and/or generative machine-learning model 121) as an input or as a condition. For example, in some cases, for example, when the desired change includes panning, apparatus 100 may select a part of image 114 (e.g., the part that will be included in image 122 after the pan) and provide the part of image 114 to generative machine-learning model 120 (or generative machine-learning model 121) as an input or condition. Generative machine-learning model 120 (and/or generative machine-learning model 121) may generate image 122 based on the at least a part of image 114 (e.g., using the at least a part of image 114 as a condition). Further, apparatus 100 may instruct generative machine-learning model 120 (and/or generative machine-learning model 121) relative to generating image 122 based on change 116. For example, processor(s) 118 may determine operational parameters or operational instructions for generative machine-learning model 120 (and/or generative machine-learning model 121) based on change 116. Image 122, generated based on image 114, may include at least part of image 114 of the field of view of image 114 and generated pixels outside of the field of view. For example, based on the desired change, image 122 may include part or all of image 114.

Additionally or alternatively, apparatus 100 (e.g., using processor(s) 118) may smooth edges between generated pixels and pixels from image 114. For example, generative machine-learning model 120 and/or generative machine-learning model 121 can be trained with images having a larger field of view (FOV) than the reference. For instance, the input images may be, or may include, a cropped smaller centered FOV image, or several cropped smaller images either centered (e.g., simultaneously captured images from multiple cameras) or centered differently (sequentially captured images from one camera). As another example, apparatus 100 may identify an edge (e.g., based on dimensions of image 114), or be informed of an edge (e.g., by generative machine-learning model 120 or generative machine-learning model 121) between generated pixels and pixels from image 114 and smooth the edge using a fusing, blending, and/or filtering technique. For example, apparatus 100 may generate a new value (e.g., a red, green, and/or blue value) for a pixel based on values of other pixels (e.g., surrounding pixels). For example, apparatus 100 may determine the new value for a pixel based on values of adjacent pixels, for example, where some of the adjacent pixels are part of the original image 114 and others of the adjacent pixels are part of the generated image data. As another example, the systems and techniques may use a filter (e.g., a 3×3 pixel filter or a 5×5 pixel filter), for example, to average pixel values across edges.

In some aspects, processor(s) 118 may cause UI 102 to display image 122 at display 104. Additionally or alternatively, processor(s) 118 may analyze image 122 or cause image 122 to be analyzed by one or more other processors. Additionally or alternatively, processor(s) 118 may cause image 122 to be stored (e.g., at a memory) or transmitted for display and/or analysis at a later time or at a different location.

By interpreting user input 110 as a change 116 relative to image 114 and instructing generative machine-learning model 120 (and/or generative machine-learning model 121) based on change 116, apparatus 100 may provide a user with an easy and convenient way to instruct generative machine-learning model 120 (and/or generative machine-learning model 121) relative to the generation of image 122. For example, based on a pinch gesture (e.g., a touch pinch gesture, a pinch gesture made with two hands, or a pinch gesture based on a user crossing their eyes), apparatus 100, through change 116, may instruct generative machine-learning model 120 (and/or generative machine-learning model 121) to generate image content to surround image 114 in image 122 (e.g., as if image 122 was image 114 were captured with a wider field of view). As another example, based on a drag gesture (e.g., a drag touch gesture, a drag gesture made with one or more hands of a user, or a drag gesture based on a user gazing at one side of an image), apparatus 100, through change 116, may instruct generative machine-learning model 120 (and/or generative machine-learning model 121) to generate image content on a side of image 114 in image 122 (e.g., as if image 122 was image 114 were captured of a panned field of view). As another example, based on a rotating gesture (e.g., based on a rotating pinch gesture, a rotating gesture made with hands, or an eye roll gesture), apparatus 100, through change 116, may instruct generative machine-learning model 120 (and/or generative machine-learning model 121) to generate image content to fill corners of image 122 around a rotated version of image 114 in image 122 (e.g., as if image 122 was image 114 captured from a rotated camera). As another example, based on a rotation of apparatus 100, apparatus 100, through change 116, may instruct generative machine-learning model 120 (and/or generative machine-learning model 121) to generate content to a right and a left side of image 114, or above and below image 114, (e.g., as if image 122 was image 114 captured from a camera rotated 90 degrees).

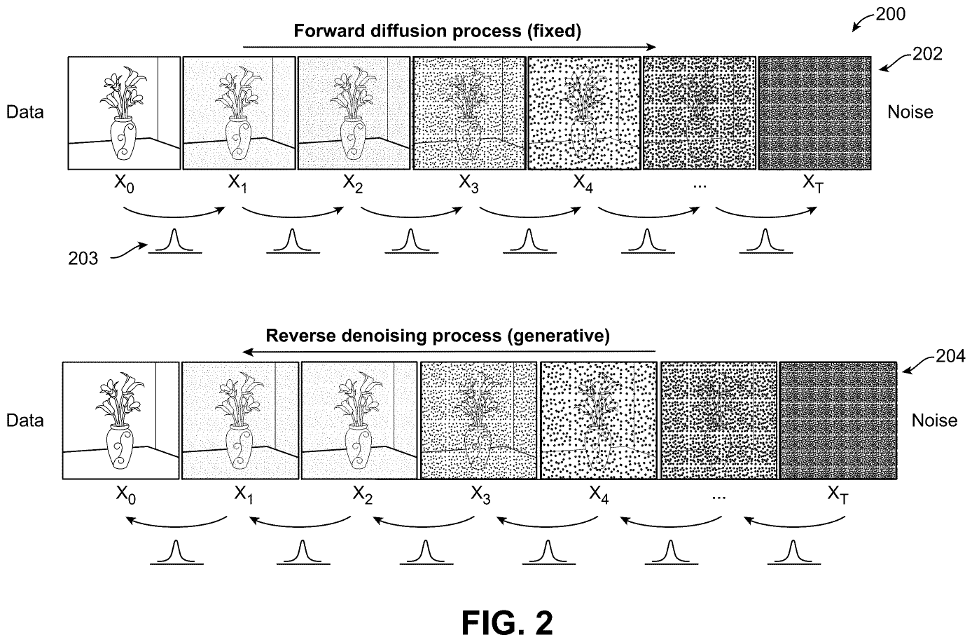

FIG. 2 provides two sets of images 200 that show the forward diffusion process (which is fixed) and the reverse diffusion process (which is learned) of a diffusion model, according to various aspects of the present disclosure. As shown in the forward diffusion process of FIG. 2, noise 203 is gradually added to a first set of images 202 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 203 is Gaussian noise. Each time step can correspond to each consecutive image of the first set of images 202 shown in FIG. 2. The initial image X₀ of FIG. 2 is of a cat. Addition of the noise 203 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian N(0,1).

The second set of images 204 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, the reverse diffusion process proceeds to generate X₀ as the image of the cat. In other cases, the input data and output data can vary based on the task for which the diffusion model is trained.

As noted above, the diffusion model is trained to be able to denoise or recover the original image X₀ in an incremental process as shown in the second set of images 204. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∞}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ N ( 0 , I ) .$$

In some cases, the βₜ values schedule (also referred to as a noise schedule) is designed such that \hat{∝}→0 and q(x_{T}|x₀)≈ [symbol] (x_{T}; 0,I).

The diffusion model runs in an iterative manner to incrementally generate the input image X₀. In one example, the model may have twenty steps. However, in other examples, the number of steps can vary.

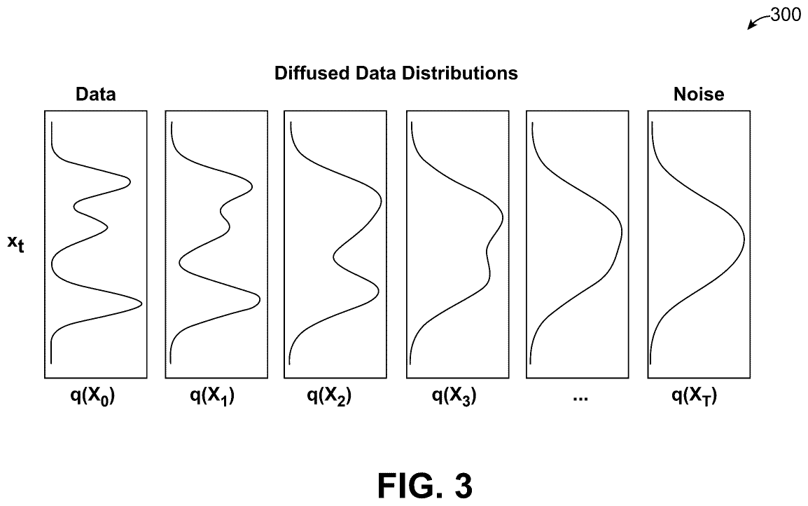

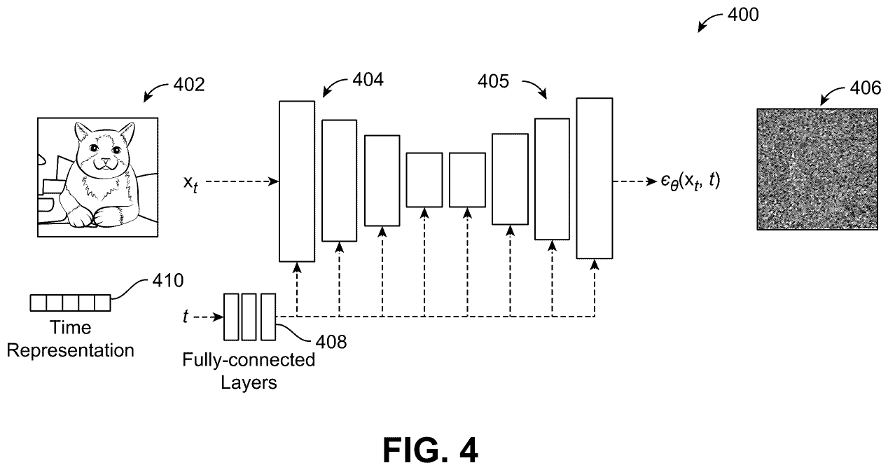

FIG. 3 is a diagram 300 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the cat shown in FIG. 4. As the diffusion model iterates and iteratively adds sampled noise to the data from t=0 to t=T, as shown in FIG. 3, the data becomes nosier and may ultimately result in pure noise (e.g., at q(X_{T})). The example of FIG. 3 illustrates the progression of the data and how it becomes diffused with noise in the forward diffusion process.

In some aspects, the diffused data distribution (e.g., as shown in FIG. 3) can be as follows:

$$q ( {x}_{t} ) = \int q ( {x}_{0} , {x}_{t} ) d {x}_{0} = \int q ( {x}_{0} ) q ( {x}_{t} \vert {x}_{0} ) d {x}_{0} .$$

In the above equation, q(xₜ) represents the diffused data distribution, q(x₀, xₜ) represents the joint distribution, q(x₀) represents the input data distribution, and q(xₜ|x₀) is the diffusion kernel. In this regard, the model can sample xₜ~q(xₜ) by first sampling X₀~q(x₀) and then sampling xₜ~q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

| 1: | repeat |
|---|---|
| 2: | x₀ ~ q(x₀) |
| 3: | t ~ Uniform ({1,...,T }) |
| 4: | ∈ ~ [symbol] (0,I) |
| 5: | Take gradient descent step on |
| ∇_{Ø} ∥ ∈ − ∈_{Ø} (\sqrt{\hat{α}ₜ x₀}+ \sqrt{1 − \hat{α}ₜ}∈, t) ∥² | |
| 6: | until converged |

A sampling algorithm can include the following steps:

1: x_{T} ~ [symbol] (0, I)
2: for t = T, . . . , 1 do
3: z ~ [symbol] (0,I)
4: ${x}_{t - 1} = \frac{1}{\sqrt{\hat{{∝}_{t}}}} ( {x}_{t} - \frac{1 - \hat{{∝}_{t}}}{\sqrt{1 - \hat{{∝}_{t}}}} {∈}_{∅} ( {x}_{t} , t ) ) + {σ}_{t} z$
5: end for
6: return x₀

FIG. 4 is a diagram illustrating a system (U-Net architecture) 400 for a diffusion model, in accordance with some aspects. The initial image 402 (e.g., of a cat) is provided to the U-Net architecture 400 which includes a series of residual networks (ResNet) blocks and self-attention layers to represent the network ϵ_{θ} (xₜ, t). The U-Net architecture 400 also includes fully connected layers 408. In some cases, time representation 410 can be sinusoidal positional embeddings or random Fourier features. Noisy output 406 from the forward diffusion process is also shown.

The U-Net architecture 400 includes a contracting path 404 and an expansive path 405 as shown in FIG. 4, which gives it the U-shaped architecture. The contracting path 404 can be a convolutional network that includes repeated convolutional layers (that apply convolutional operations), each followed by a rectified linear unit (ReLU) and a max pooling operation. When images are being processed (e.g., the image 402) during the contracting path 404, the spatial information of the image 402 is reduced as features are generated. The expansive path 405 combines the features and spatial information through a sequence of up-convolutions and concatenations with high-resolution features from the contracting path 404. Some of the layers can be self-attention layers, which leverage global interactions between semantic features at the end of the encoder to explicitly model full contextual information.

Systems, apparatuses, electronic devices, methods (also referred to as processes), and computer-readable media (collectively referred to herein as “systems and techniques”) are described herein for generating content personalization. As discussed, existing systems for content personalization are deficient. For example, existing solutions may be unable to generate temporally consistent and photo-realistic video content based on text prompts. Such existing solutions are unable to disentangle features in reference content that relate to motion from features in the reference content that relate to appearance, which results in output content (e.g., an output video) that does not properly reflect the desired appearance and motion.

The systems and techniques described herein can be used to generate personalized content (e.g., videos) that are temporally consistent and photo realistic. For instance, the systems and techniques can use one or more machine learning models that employ temporal shared attention during inference, which results in improved style alignment with a reference image, and therefore higher quality and consistent outputs. In one illustrative example, a user provides to a system a reference image (also referred to as a source image) depicting an object of interest (e.g., an individual, an animal, etc.) and a reference video (also referred to as a source video) depicting a sequence of movement (e.g., a different object, such as a different person, moving in a particular manner). The user can provide input (e.g., by inputting a prompt, which can be referred to as an instruction prompt) to the system via a user interface (e.g., a keyboard input, a voice input, a touch input, a gesture input, etc.) instructing the system to generate a video of the object of interest moving according to the movement represented in the reference video. Examples of instruction prompts include “generate a video of the reference image according to movement within the reference video,” “generate a video of my dog surfing on the ocean,” and “generate a video of a superhero performing the Dab motion.”

According to some aspects, the systems and techniques can use multiple machine learning models and leverage temporal shared attention between layers of the machine learning models, thereby extracting motion information between frames of the reference video. More specifically, disclosed techniques provide frames of reference video augmented with inverted noise and the reference image to a first machine learning model (e.g., a diffusion model) and provide Gaussian noise and the reference image to a second machine learning model. The first and second machine learning models are connected via one or more temporal shared attention blocks. The temporal shared attention blocks share features between the layers of the first and second machine learning models such that the motion between video frames is represented in a feature space. In doing so, the systems and techniques can improve upon previous spatial shared attention approaches, such as by being able to represent and transfer the temporal information. In some cases, the systems and techniques neither require video-specific fine tuning nor training of models based on specific videos.

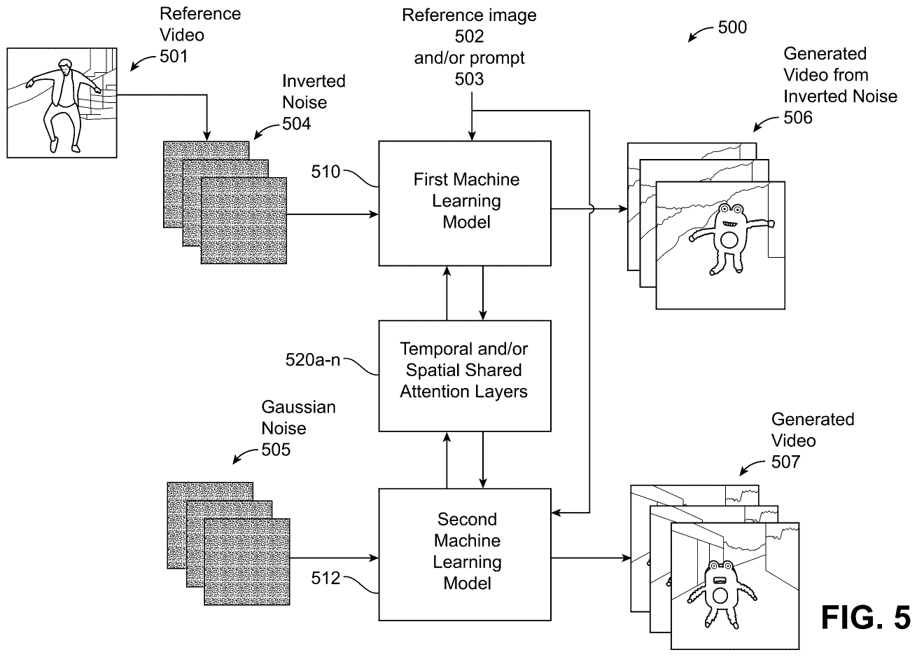

FIG. 5 is a diagram illustrating a system 500 for motion customization via shared attention, in accordance with some aspects of the present disclosure. As described in more detail below, the system 500 can generate personalized videos (e.g., output video 507) from one or more reference videos (e.g., reference video 501), one or more reference images (e.g., reference image 502), and in some cases one or more prompts (e.g., a prompt 503).

As shown in FIG. 5, the system 500 includes a first machine learning model 510 and a second machine learning model 512. The first machine learning model 510 and the second machine learning model 512 are interconnected via one or more shared attention layers 520a-n. Use of the one or more shared attention layers 520a-n enables analysis and representation of temporal information (e.g., motion information), which can allow the system 500 to generate improved output video content. In some aspects, the first machine learning model 510 and/or second machine learning model 512 may be a diffusion model, such as the U-Net architecture 400 of FIG. 4. For instance, the fully connected layers 408 of FIG. 4 may correspond to the layers of first machine learning model 510 or second machine learning model 512.

The system 500 can receive the reference video 501, the reference image 502, and in some cases the prompt 603. In one illustrative example, the prompt 503 can be “monster toy dancing.” In some cases, the prompt 503 can include a reference to the reference image 502 (e.g., “monster toy dancing like in reference image 502”). The system 500 can generate the output video 507 using the reference video 501, the reference image 502, and in some cases the prompt 503 as input.

According to some aspects, system 500 can generate inverted noise 504 from the reference video 501. The inverted noise 504 can include one or more frames of inverted noise. The inverted noise 504 generated from the reference video 501, the reference image 502, and the optional prompt 503 can be provided as input to the first machine learning model 510. The system 500 can also generate or access Gaussian noise 505, which may include one or more frames of noise. The Gaussian noise 505, the reference image 502, and the optional prompt 503 can be provided as input to the second machine learning model 512. The first machine learning model 510 can iteratively process the inverted noise 504, the reference image 502, and the optional prompt 503 to iteratively generate video frames of an output video 506. The second machine learning model 512 can iteratively process the Gaussian noise 505, the reference image 502, and the optional prompt 503 to generate output video 507, which depicts the object depicted in the reference image 502 moving according to represented in video 501. In some cases, the video 506 can be discarded, such that only the output video 507 is used.

As explained in more detail below, first machine learning model 510 and second machine learning model 512 each include multiple layers. As noted previously, the layers of first machine learning model 510 and second machine learning model 512 may be interconnected by one or more shared attention layers 520a-n, which as explained below, may be spatial and/or temporal shared attention layers.

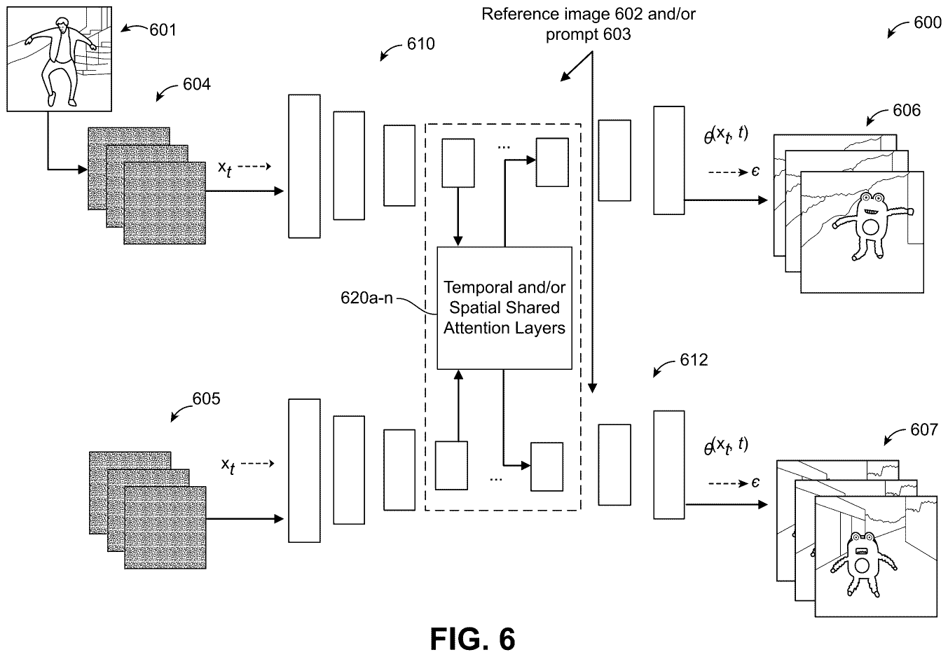

FIG. 6 is a diagram illustrating a system 600 for motion customization via shared attention, in accordance with some aspects of the present disclosure. The system 600 is configurable to generate personalized video (e.g., an output video 607) from one or more reference videos (e.g., a reference video 601), one or more reference images (e.g., a reference image 602), and in some cases one or more prompts (e.g., the prompt 603).

The system 600 uses two diffusion models to generate the personalized video. For instance, as shown, the system 600 includes a first diffusion model 610 and a second diffusion model 612, which use one or more shared attention layers 620a-n to generate improved video content. The system 600 can receive the reference video 601, the reference image 602, and the optional prompt 603. The system 600 can generate inverted noise 604 from the reference video 601. The system 600 can provide the inverted noise 604 generated from the reference video 601, the reference image 602, and the optional prompt 603 as input to first diffusion model 610. The system 600 can also provide Gaussian noise 605, the reference image 602, and the optional prompt 603 as input to the second diffusion model 612.

The first diffusion model 610 can de-noise the inverted noise 604 and can use the reference image 602 and/or the prompt 603 as guidance, to generate the output video 606. The second diffusion model 612 can de-noise the Gaussian noise 605 and can use the reference image 602 and/or the prompt 603 as guidance, to generate the output video 607. The first diffusion model 610 and the second diffusion model 612 can generate the videos 606 and 607, respectively, simultaneously in an iterative manner (e.g., where one video frame of each video 606 and 607 is generated at each iteration of the first diffusion model 610 and the second diffusion model 612, respectively). The output video 607 may be output, for instance, to a display device. The video 606 may be discarded or not generally used (e.g., for display, etc.).

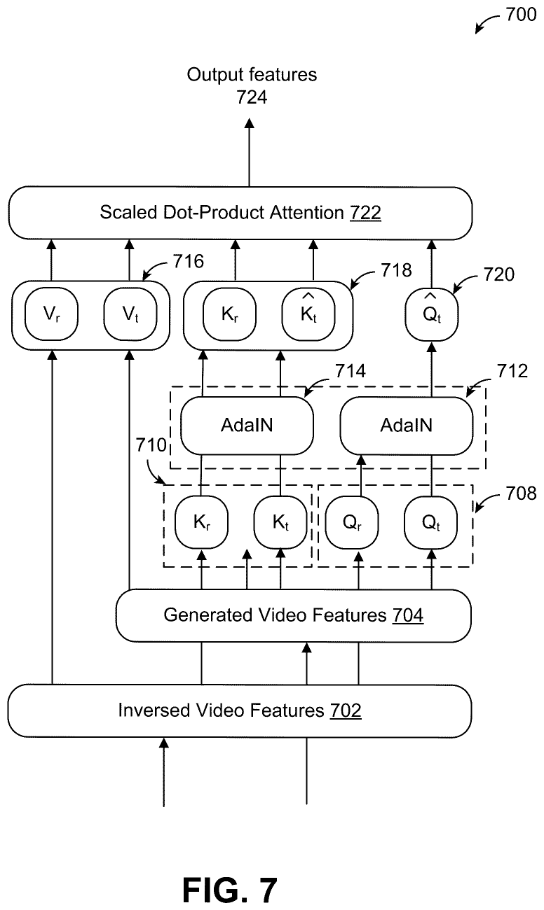

As can be seen, each of first diffusion model 610 and second diffusion model 612 include layers, which may be similar to the layers of the U-Net architecture 400 of FIG. 4. The layers of first diffusion model 610 and second diffusion model 612 are interconnected by one or more shared attention layers 620a-n, which can include a single layer (in which case n=0) or multiple layers (in which case n is equal to a value greater than or equal to 1). Each shared attention layer 620a-n may receive as input features from one or more input layers (e.g., of the first diffusion model 610, the second diffusion model 612, and/or prior layers of the shared attention layers 620a-n), perform operations such as generating one or more queries, keys, and values, and performing one or more functions (e.g., adaptive instance normalization (AdaIN) and/or other function(s)) over the queries, keys, and values. This process is explained further with respect to FIG. 7.

The one or more shared attention layers 620a-n may be temporal or spatial in nature. Accordingly, the output features from a given shared attention layer of the one or more shared attention layers 620a-n may be provided to another layer within the same diffusion model and/or to a different layer within the same diffusion model or the other diffusion model. For example, features derived from a layer of the first diffusion model 610 may be processed and provided as input features to a layer of the second diffusion model 612, and vice versa. The resulting features output from the one or more shared attention layers 620a-n can be output to one or more other layers of the first diffusion model 610 and the second diffusion model 612.

In some aspects, a shared attention layer of the one or more shared attention layers 620a-n may connect layers of the first and second diffusion models 610 and 612 to facilitate temporal shared attention, such as to transfer motion-based information of the reference video 601 to facilitate output of the output video 607 having motion that accurately conveys the motion in the reference video 601. Layer 700 of FIG. 7 described in detail below is one illustrative example of such a shared attention layer. For example, the first diffusion model 610 can determine (e.g., extract) motion information from the inverted noise 604 (which is based on the video frames of the reference video 601). The motion information can be transferred between the first and second diffusion models 610 and 612 (e.g., from the first diffusion model 610 to the second diffusion model 612) via the one or more shared attention layers 620a-n.

In some cases, one or more Spatial Low-Rank Adaptation (LoRA) models (e.g., adapters) may be attached to one or more of the machine learning models (e.g., the first diffusion model 610, the second diffusion model 612, and/or the one or more shared attention layers 620a-n). Each spatial LoRA may be trained on a specific appearance (e.g., a subject), which can improve generation of videos that accurately reflect both appearance and motion. Spatial LoRA may be attached to the weights within the spatial self-attention block of a diffusion model (e.g., the first diffusion model 610 and/or the second diffusion model 612). By being attached to the spatial self-attention block, the spatial LoRa can focus on learning spatial information in one or more frames, such as appearance. In some cases, temporal LoRA may be attached to the weights within the temporal self-attention block of a diffusion model (e.g., the first diffusion model 610 and/or the second diffusion model 612). By being attached to the temporal self-attention block, the Temporal LoRa can focus on learning temporal information, such as motion (e.g., across multiple video frames). Spatial self-attention and temporal self-attention may differ in that spatial self-attention computes attention maps between features of each pixel in a frame, whereas temporal self-attention computes attention maps between features of each time step (e.g., across video frames).

FIG. 7 is a diagram illustrating a shared attention layer 700, in accordance with some aspects of the present disclosure. As noted previously, the shared attention layer 700 is an example of a layer of the one or more shared attention layers 620a-n of FIG. 6. In the example depicted, the shared attention layer 700 can receive as input reference features 702 and target features 704. The shared attention layer 700 can generate output features 724 by generating one or more queries, keys, and values from the reference features 702 and the target features 704. In some aspects, the shared attention layer 700 can perform adaptive instance normalization (AdaIN) and/or other functions over the one or more queries, keys, and values.

Inversed video features 702 represent features (e.g., feature maps, embeddings, and/or other feature representation) generated from reference images or frames (e.g., from frames of the inverse noise 604 generated based on the reference video 601 of FIG. 6) by one or more layers of a diffusion model (e.g., the first diffusion model 610 and/or the second diffusion model 612 of FIG. 6). Generated video features 704 represent features (e.g., feature maps, embeddings, and/or other feature representation) generated from Gaussian noise (e.g., the Gaussian noise 605 of FIG. 6) and that represent frames of a generated video (e.g., the output video 607). The generated video features 704 can be referred to as shared attention features. The output video 607 can then be utilized as a final generated video for output (e.g., for display, storage, transmission, etc.).

The shared attention layer 700 can use the inversed video features 702 and the generated video features 704 to generate value Vᵣ and value Vₜ in block 716, keys Ky and Kₜ in block 710, and queries Qᵣ and Qₜ in block 708. For example, the features 702 and 704 can be projected into queries Q∈m×dk, keys K∈m×dk and values V∈m×dh through learned linear layers. The shared attention layer 700 can then perform adaptive instance normalization (AdaIN) at block 714 over keys Kᵣ and Kₜ, resulting in keys Kᵣ and [symbol] at block 718. The shared attention layer 700 can also perform ADaIN at block 712 over queries Qᵣ and Qₜ to generate query [symbol] at block 720. The AdaIN operation can be represented as follows:

$$AdaIn ( x , y ) = σ ( y ) ( \frac{x - μ ( x )}{σ ( x )} ) + {μ}_{y}$$

where the keys Kᵣ and Kₜ can be used as the x and y inputs, respectively, of the AdaIN operation at block 714 and the queries Qᵣ and Qₜ can be used as the x and y inputs, respectively, of the AdaIN operation at block 712.

The shared attention layer 700 can then perform scaled dot product attention at block 722 on values Vᵣ and Vₜ from block 716, keys Kᵣ and [symbol] from block 718, and query [symbol] from block 720 to generate output features 724. The scaled dot product attention can be represented as follows:

$$Attention ( \text{?} , {K}_{rt}^{T} , {V}_{rt} ) , where {K}_{rt}^{T} = [ \frac{{K}_{r}}{\text{?}} ] and {V}_{rt}^{T} = [ \begin{matrix}{V}_{r} \\ t\end{matrix} ]$$

The output features 724 are an example of the output of the one or more shared attention layers 620a-n of FIG. 6. As described with respect to FIG. 6, the output features 724 can be provided as input to layers of the machine learning models, such as the diffusion models 610 and 612.

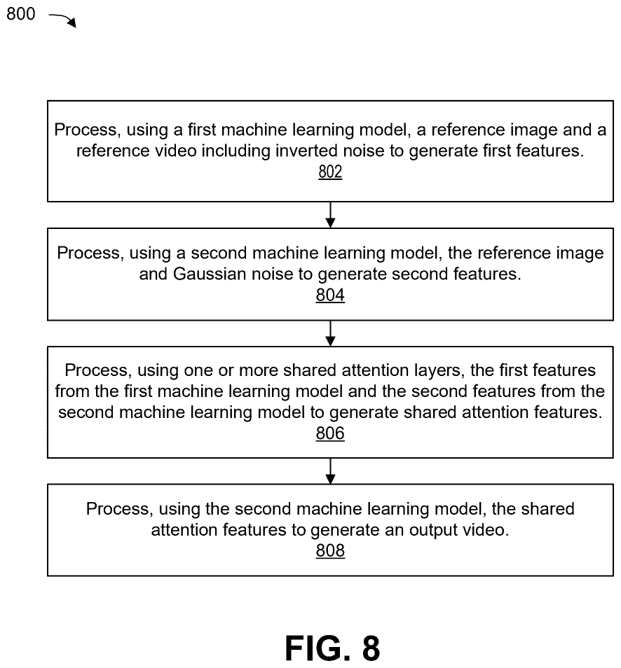

FIG. 8 is a flow diagram of an example of a process 800 for generating content in accordance with some aspects of the disclosure. The process 800 can be performed by a computing device (or apparatus) or a component (e.g., one or more chipsets, one or more processors such as one or more CPUs, DSPs, NPUs, NSPs, microcontrollers, ASICS, FPGAs, programmable logic devices, discrete gates or transistor logic components, discrete hardware components, etc., an ML system such as a neural network model, any combination thereof, and/or other component or system) of the computing device. The computing device may be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device. The operations of the process 800 may be implemented as software components that are executed and run on one or more processors (e.g., the processor 1102 of FIG. 11 and/or other processor(s)).

At block 802, the computing device (or component thereof) can process, using a first machine learning model (e.g., the first machine learning model 510 of FIG. 5, the first diffusion model 610 of FIG. 6, etc.), a reference image (e.g., reference image 502 of FIG. 5, the reference image 602 of FIG. 6, etc.) and a reference video (e.g., reference video 501 of FIG. 5, the reference video 601 of FIG. 6, etc.) including inverted noise (e.g., inverted noise 504 of FIG. 5, inverted noise 604 of FIG. 6, etc.) to generate first features.

At block 804, the computing device (or component thereof) can process, using a second machine learning model (e.g., the second machine learning model 512 of FIG. 5, the second diffusion model 612 of FIG. 6, etc.), the reference image and Gaussian noise (e.g., Gaussian noise 505 of FIG. 5, Gaussian noise 605 of FIG. 6, etc.) to generate second features.

In some aspects, the first machine learning model includes at least a first layer and a second layer (e.g., as shown in FIG. 6). In some aspects, the second machine learning model includes at least a third layer and a fourth layer (e.g., as shown in FIG. 6).

In some aspects, the first features represent motion information between frames of the reference video. In some aspects, the second features represent features from images generated from the Gaussian noise. In some aspects, the computing device (or component thereof) can add the inverted noise to the reference video prior to processing the reference video using the first machine learning model.

In some aspects, one or more of the first machine learning model and the second machine learning model includes an additional shared attention layer that shares spatial features (e.g., as illustrated in and discussed with respect to FIG. 6 and FIG. 7). In some aspects, the first machine learning model is a first diffusion model (e.g., the first diffusion model 610 of FIG. 6) and/or the second machine learning model is a second diffusion model (e.g., the second diffusion model 612 of FIG. 6). In some aspects, the computing device (or component thereof) can receive a user prompt (e.g., the user prompt 503 of FIG. 5, the user prompt 603 of FIG. 6, etc.) and provide the user prompt to one or more of the first machine learning model and the second machine learning model (e.g., as illustrated in and discussed with respect to FIG. 5 and FIG. 6).

At block 806, the computing device (or component thereof) can process, using one or more shared attention layers (e.g., the shared attention layers 520a-n of FIG. 5, the shared attention layers 620a-n of FIG. 6, the layer 700 of FIG. 7, etc.), the first features from the first machine learning model and the second features from the second machine learning model to generate shared attention features (e.g., generated video features 704 of FIG. 7). In some aspects, the shared attention features include third features and fourth features. In some aspects, to generate the third features and the fourth features, the computing device (or component thereof) can generate using the one or more shared attention layers, one or more queries, keys, and values (e.g., the values Vᵣ and Vₜ, the keys Kᵣ and Kₜ, and the queries Qᵣ and Qₜ of FIG. 7, the of FIG. 7, etc.) from the first features and the second features. The computing device (or component thereof) can process, using the one or more shared attention layers, the one or more queries, keys, and values using adaptive instance normalization (e.g., the AdaIN block 712 and/or the AdaIn block 714 of FIG. 7) to generate the third features and the fourth features. In some aspects, the first machine learning model is trained to identify motion in video sequences. The fourth features represent identified motion in the first reference video. The second machine learning model apply the identified motion to the reference image.

At block 808, the computing device (or component thereof) can process, using the second machine learning model, the shared attention features to generate an output video (e.g., the generated video 507 of FIG. 5, the output video 607 of FIG. 6, etc.).

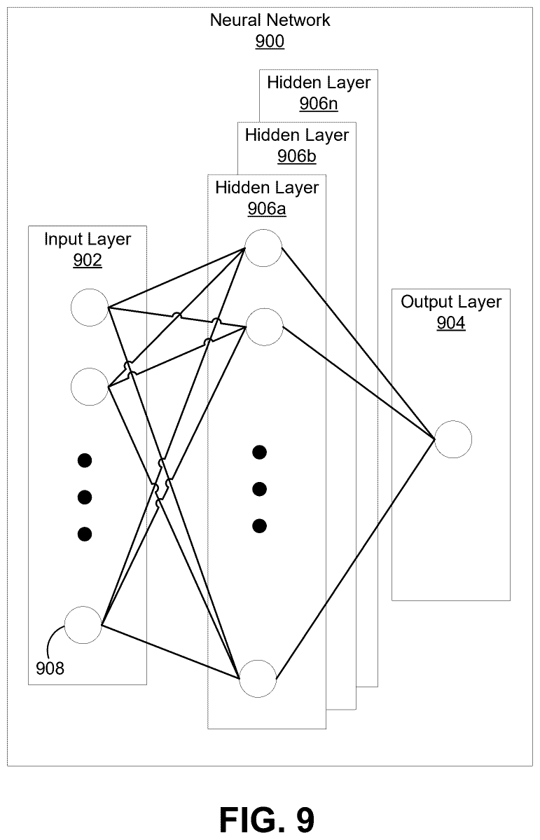

As described herein, the systems and techniques described herein can be performed using one or more machine learning models, such as one or more neural networks. FIG. 9 is an illustrative example of a neural network 900 (e.g., a deep-learning neural network), in accordance with some aspects of the present disclosure. Examples of machine-learning based aspects include image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 900 may be an example of, or can implement, generative machine-learning model 120, and/or generative machine-learning model 121.

Neural network 900 includes multiple hidden layers hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

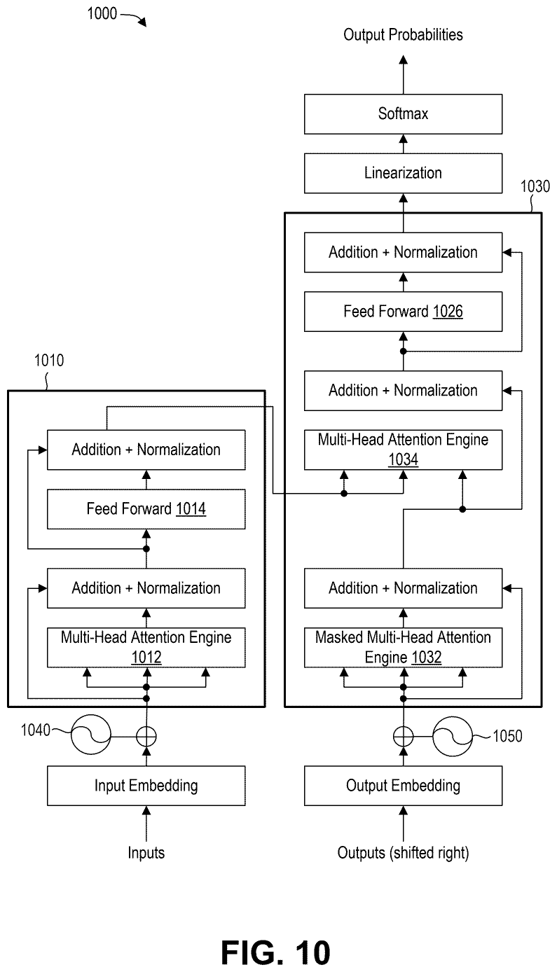

FIG. 10 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1000 reduces the operations of learning dependencies by using an encoder 1010 and a decoder 1030 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1010 is composed of a stack of six identical layers and each layer has two sub-layers. The first sub-layer is a multi-head self-attention engine 1012, and the second sub-layer is a fully connected feed-forward network 1014. A residual connection (not shown) connects around each of the sub-layers followed by normalization.

In this example transformer 1000, the decoder 1030 is also composed of a stack of six 6 identical layers. The decoder also includes a masked multi-head self-attention engine 1032, a multi-head attention engine 1034 over the output of the encoder 1010, and a fully connected feed-forward network 1026. Each layer includes a residual connection (not shown) around the layer, which is followed by layer normalization. The masked multi-head self-attention engine 1032 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1040 to encode positions because the model does not contain recurrence and convolution and relative or absolute position of the tokens is needed. In the transformer 1000, the positional encodings are added to the input embeddings at the bottom layer of the encoder 1010 and the decoder 1030. The positional encodings are summed with the embeddings because the positional encodings and embeddings have the same dimensions. A corresponding position decoder 1050 is configured to decode the positions of the embeddings for the decoder 1030.

In some aspects, the transformer 1000 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1000 can process input sequences of variable length, making it well-suited for natural language processing tasks where input lengths can vary greatly. Additionally, the self-attention mechanism allows the transformer 1000 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

In some cases, the devices or apparatuses configured to perform the operations of the process 800 and/or other processes described herein may include a processor, microprocessor, microcomputer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of apparatus 100, U-Net architecture 400, system 500, system 600, layer 700, neural network 900, and transformer 1000, etc. Additionally or alternatively, computing-device architecture 1100 may be configured to perform process 800, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process May correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating image content, the apparatus comprising: at least one memory; and at least one processor coupled to the at least one memory and configured to: process, using a first machine learning model, a reference image and a reference video including inverted noise to generate first features; process, using a second machine learning model, the reference image and Gaussian noise to generate second features; process, using one or more shared attention layers, the first features from the first machine learning model and the second features from the second machine learning model to generate shared attention features; and process, using the second machine learning model, the shared attention features to generate an output video.
Aspect 2. The apparatus of Aspect 1, wherein the first machine learning model comprises at least a first layer and a second layer, and wherein the second machine learning model comprises at least a third layer and a fourth layer, and wherein the shared attention features include third features and fourth features.
Aspect 3. The apparatus of Aspect 2, wherein, to generate the third features and the fourth features, the at least one processor is configured to: generate, using the one or more shared attention layers, one or more queries, keys, and values from the first features and the second features; and process, using the one or more shared attention layers, the one or more queries, keys, and values using adaptive instance normalization to generate the third features and the fourth features.
Aspect 4. The apparatus of any of Aspects 2 or 3, wherein the first machine learning model is trained to identify motion in video sequences, wherein the fourth features represent identified motion in the reference video, and wherein the second machine learning model applies the identified motion to the reference image.
Aspect 5. The apparatus of any of Aspects 1 to 4, wherein the first features represent motion information between frames of the reference video.
Aspect 6. The apparatus of any of Aspects 1 to 5, wherein the second features represent features from images generated from the Gaussian noise.
Aspect 7. The apparatus of any of Aspects 1 to 6, wherein the at least one processor is configured to add the inverted noise to the reference video prior to processing the reference video using the first machine learning model.
Aspect 8. The apparatus of any of Aspects 1 to 7, wherein one or more of the first machine learning model and the second machine learning model comprises an additional shared attention layer that shares spatial features.
Aspect 9. The apparatus of any of Aspects 1 to 8, wherein the first machine learning model is a first diffusion model, and wherein the second machine learning model is a second diffusion model.
Aspect 10. The apparatus of any of Aspects 1 to 9, wherein the at least one processor is configured to receive a user prompt and provide the user prompt to one or more of the first machine learning model and the second machine learning model.
Aspect 11. A method for generating image content, the method comprising:
processing, using a first machine learning model, a reference image and a reference video including inverted noise to generate first features; processing, using a second machine learning model, the reference image and Gaussian noise to generate second features; processing, using one or more shared attention layers, the first features from the first machine learning model and the second features from the second machine learning model to generate shared attention features; and processing, using the second machine learning model, the shared attention features to generate an output video.
Aspect 12. The method of Aspect 11, wherein the first machine learning model comprises at least a first layer and a second layer, and wherein the second machine learning model comprises at least a third layer and a fourth layer, and wherein the shared attention features include third features and fourth features.
Aspect 13. The method of Aspect 12, wherein generating the third features and the fourth features further comprises: generating, using the one or more shared attention layers, one or more queries, keys, and values from the first features and the second features; and processing, using the one or more shared attention layers, the one or more queries, keys, and values using adaptive instance normalization to generate the third features and the fourth features.
Aspect 14. The method of any of Aspects 12 or 13, wherein the first machine learning model is trained to identify motion in video sequences, wherein the fourth features represent identified motion in the reference video, and wherein the second machine learning model applies the identified motion to the reference image.
Aspect 15. The method of any of Aspects 11 to 14, further comprising adding the inverted noise to the reference video prior to processing the reference video using the first machine learning model.
Aspect 16. The method of any of Aspects 11 to 15, wherein one or more of the first machine learning model and the second machine learning model comprises an additional shared attention layer that shares spatial features.
Aspect 17. The method of any of Aspects 11 to 16, wherein the first machine learning model is a first diffusion model, and wherein the second machine learning model is a second diffusion model.
Aspect 18. The method of any of Aspects 11 to 17, further comprising receiving a user prompt and providing the user prompt to one or more of the first machine learning model and the second machine learning model.
Aspect 19. A non-transitory computer-readable medium is provided that has stored thereon instructions that, when executed by one or more processors, cause the one or more processors to: process, using a first machine learning model, a reference image and a reference video including inverted noise to generate first features; process, using a second machine learning model, the reference image and Gaussian noise to generate second features; process, using one or more shared attention layers, the first features from the first machine learning model and the second features from the second machine learning model to generate shared attention features; and process, using the second machine learning model, the shared attention features to generate an output video.
Aspect 20. A non-transitory computer-readable medium having stored thereon instructions that, when executed by at least one processor, cause the at least one processor to perform operations according to any one or more of Aspects 11 to 18.
Aspect 22. An apparatus including one or more means for performing operations according to any one or more of Aspects 11 to 18.

What is claimed is:

1. An apparatus for generating image content, the apparatus comprising:
at least one memory; and
at least one processor coupled to the at least one memory and configured to:
process, using a first machine learning model, a reference image and a reference video including inverted noise to generate first features;
process, using a second machine learning model, the reference image and Gaussian noise to generate second features;
process, using one or more shared attention layers, the first features from the first machine learning model and the second features from the second machine learning model to generate shared attention features; and
process, using the second machine learning model, the shared attention features to generate an output video.

2. The apparatus of claim 1, wherein the first machine learning model comprises at least a first layer and a second layer, and wherein the second machine learning model comprises at least a third layer and a fourth layer, and wherein the shared attention features include third features and fourth features.

3. The apparatus of claim 2, wherein, to generate the third features and the fourth features, the at least one processor is configured to:
generate, using the one or more shared attention layers, one or more queries, keys, and values from the first features and the second features; and
process, using the one or more shared attention layers, the one or more queries, keys, and values using adaptive instance normalization to generate the third features and the fourth features.

4. The apparatus of claim 2, wherein the first machine learning model is trained to identify motion in video sequences, wherein the fourth features represent identified motion in the reference video, and wherein the second machine learning model applies the identified motion to the reference image.

5. The apparatus of claim 1, wherein the first features represent motion information between frames of the reference video.

6. The apparatus of claim 1, wherein the second features represent features from images generated from the Gaussian noise.

7. The apparatus of claim 1, wherein the at least one processor is configured to add the inverted noise to the reference video prior to processing the reference video using the first machine learning model.

8. The apparatus of claim 1, wherein one or more of the first machine learning model and the second machine learning model comprises an additional shared attention layer that shares spatial features.

9. The apparatus of claim 1, wherein the first machine learning model is a first diffusion model, and wherein the second machine learning model is a second diffusion model.

10. The apparatus of claim 1, wherein the at least one processor is configured to receive a user prompt and provide the user prompt to one or more of the first machine learning model and the second machine learning model.

11. A method for generating image content, the method comprising:
processing, using a first machine learning model, a reference image and a reference video including inverted noise to generate first features;
processing, using a second machine learning model, the reference image and Gaussian noise to generate second features;
processing, using one or more shared attention layers, the first features from the first machine learning model and the second features from the second machine learning model to generate shared attention features; and
processing, using the second machine learning model, the shared attention features to generate an output video.

12. The method of claim 11, wherein the first machine learning model comprises at least a first layer and a second layer, and wherein the second machine learning model comprises at least a third layer and a fourth layer, and wherein the shared attention features include third features and fourth features.

13. The method of claim 12, wherein generating the third features and the fourth features further comprises:
generating, using the one or more shared attention layers, one or more queries, keys, and values from the first features and the second features; and
processing, using the one or more shared attention layers, the one or more queries, keys, and values using adaptive instance normalization to generate the third features and the fourth features.

14. The method of claim 12, wherein the first machine learning model is trained to identify motion in video sequences, wherein the fourth features represent identified motion in the reference video, and wherein the second machine learning model applies the identified motion to the reference image.

15. The method of claim 11, further comprising adding the inverted noise to the reference video prior to processing the reference video using the first machine learning model.

16. The method of claim 11, wherein one or more of the first machine learning model and the second machine learning model comprises an additional shared attention layer that shares spatial features.

17. The method of claim 11, wherein the first machine learning model is a first diffusion model, and wherein the second machine learning model is a second diffusion model.

18. The method of claim 11, further comprising receiving a user prompt and providing the user prompt to one or more of the first machine learning model and the second machine learning model.

19. A non-transitory computer-readable medium is provided that has stored thereon instructions that, when executed by one or more processors, cause the one or more processors to:
process, using a first machine learning model, a reference image and a reference video including inverted noise to generate first features;
process, using a second machine learning model, the reference image and Gaussian noise to generate second features;
process, using one or more shared attention layers, the first features from the first machine learning model and the second features from the second machine learning model to generate shared attention features; and
process, using the second machine learning model, the shared attention features to generate an output video.

20. The non-transitory computer-readable medium of claim 19, wherein the first machine learning model comprises at least a first layer and a second layer, and wherein the second machine learning model comprises at least a third layer and a fourth layer, and wherein the shared attention features include third features and fourth features and wherein generating the third features and the fourth features comprises:
generating, using the one or more shared attention layers, one or more queries, keys, and values from the first features and the second features; and
processing, using the one or more shared attention layers, the one or more queries, keys, and values using adaptive instance normalization to generate the third features and the fourth features.
